(19) United States
(12) Patent Application Publication
(10) Pub. No.: US 2010/0141381 A1
(43) Pub. Date: Jun. 10, 2010

(54) ACCESS CONTROL SYSTEM, LOCK DEVICE, ADMINISTRATION DEVICE, AND ASSOCIATED METHODS AND COMPUTER PROGRAM PRODUCTS

(76) Inventors: Olle Bliding, Halmstad (SE); Lars Knutsson, Halmstad (SE); Jonas Runesson, Halmstad (SE); Johan Karlsson, Eldsberga (SE)

Correspondence Address: HARNESS, DICKEY & PIERCE, P.L.C., P.O. BOX 8910, RESTON, VA, 20195, US

(21) Appl. No.: 12/448,434

(22) PCT Filed: Dec. 19, 2007
(86) PCT No.: PCT/SE2007/051042

§ 371 Date: Jan. 14, 2010

(30) Foreign Application Priority Data
Dec. 20, 2006 (SE) 0602754-4

(51) Int. Cl. G05B 19/00

(52) U.S. Cl. 340/5.61

(57) ABSTRACT

An access control system uses an existing file format standard, e.g. for personal data interchange (PDI) or image file interchange, for novel access control purposes to provide temporary access for a wireless key device to a lock device and its protected environment by creating appropriate temporary access defining data in a data object compliant with the file format standard and communicating the data object to the lock device via the wireless key device.

### FIELD OF THE INVENTION

The present invention relates to access control systems, and more particularly to an access control system in which a wireless key device can be provided temporary access to an environment protected by a lock device. The invention also relates to an associated lock device, an associated administration device for providing temporary access to the lock device for a user of a wireless key device, as well as associated methods and computer program products.

### BACKGROUND OF THE INVENTION

WO 2006/098690 discloses an access control system in which users of wireless key devices can get access to an environment protected by a lock device by means of short-range wireless data communication technology such as Bluetooth®. A lock device performs authentication of a wireless key device by checking, among other things, the Bluetooth® address of the key device.

The key devices of WO 2006/098690 are high-end mobile phones which are provided with customized access control software for handling their appropriate authentication via short-range wireless data communication (Bluetooth communication) with the lock device. Using such mobile phones with customized software provides user-friendliness as well as a high degree of security thanks to a two-stage authentication procedure proposed in WO 2006/098690. It also allows for convenient updating of the database of a particular lock device by using the customized access control software in the mobile phone as a relay station for forwarding lock device updating data in a secure manner from a remote administration device via a mobile telecommunications network.

Thus, in the solution of WO 2006/098690, if a new person is to be added as an allowed user for a certain lock device, one of two possible ways must be employed:

The first way is to provide the lock device in advance with database updating data which indicates the new user (or rather his mobile phone) as allowed. This may be done by bringing a special administration device close to the lock device for direct wireless data transmission of the updating data to the lock device, or it may be done by sending the updating data to another key device which will bring it to the lock device when seeking access to it at some earlier point in time.

The second way involves using the particular new user's own mobile phone for bringing about the database updating data. In order for this to work, the user's mobile phone must at least have been upgraded in advance to include the required customized access control software, since this software is needed in order to perform a second-stage authentication during which upgrading of the lock device's database must take place.

Since both these ways require certain actions to be taken in advance, the system of WO 2006/098690 is less convenient when a new user only needs temporary access to a certain lock device. There may be many situations where a new user may need temporary access. One example is when a craftsman or repair man needs to access an apartment in order to repair or replace something in the apartment (e.g. a plumper repairing a pipe, or a glazier replacing a window pane). One difficulty for an administrator of an access control system of the kind used WO 2006/098690 when wanting to give temporary access for a new user, which only has a standard mobile terminal to use as key device, would be that the new user must inform the administrator about the Bluetooth® address of his mobile terminal. However, it is difficult for an ordinary user to find out the Bluetooth® address of the Bluetooth® transceiver in a mobile terminal.

### SUMMARY OF THE INVENTION

In view of the above, an objective of the invention is to solve or at least reduce the problems discussed above. More particularly, a purpose of the invention is to enable temporary access via a lock device to a protected environment in an access control system also for a user which does not possess a wireless key device which has been configured in advance for such purposes (for instance, having been provided with customized software for handling appropriate authentication via short-range wireless data communication with the lock device). Thus, the invention seeks to provide such temporary access by using standard wireless key devices such as mobile terminals that only contain standard mobile phone software but not any customized one for access control.

Generally, the above objectives and purposes are achieved by an access control system, a lock device and an administration device, as well as associated methods and computer program products, according to the attached independent patent claims.

A first aspect of the invention is an access control system including:

a lock device for a protected environment, said lock device comprising short-range wireless data communication means capable of short-range wireless data communication based on a communication identifier of said lock device;

a wireless key device having short-range wireless data communication means and data interchange means for communication of data objects compliant with a file format standard; and

an administration device comprising:
generator means for generating a data object in accordance with said file format standard, a first property of said generated data object being assigned the communication identifier of said lock device, and at least a second property of said generated data object being assigned temporary access defining data for said key device to said environment protected by said lock device, and
transmitter means for transmitting said generated data object to said key device;

wherein said lock device further comprises:
processing means, associated with said short-range wireless data communication means, for processing said data object as received and forwarded by said key device,
verification means for verifying that said first property of the received data object matches the communication identifier of the lock device, and
access control means, responsive to successful verification by said verification means, for providing temporary access for said key device in accordance with said second property of the received data object.

The short-range wireless data communication means of the lock device may comprise a radio transceiver, preferably a Bluetooth® transceiver or another commercially available radio transceiver for one or more unlicensed RF communication frequencies or frequency bands. In such embodiments, the communication identifier of the lock device may advantageously be the unique Bluetooth communication address which is assigned to every Bluetooth transceiver chip in conjunction with the manufacture thereof or later. As an alternative for such or other embodiments, the communication identifier of the lock device may be comprised by unique identifying data which is included in the payload of the communication traffic to the lock device and which is compared at the reception thereof with prestored reference data in order to determine that the communication traffic is intended for the particular lock device in question.

In one advantageous embodiment, the data interchange means of the wireless key device is in the form of personal data interchange means for communication of data objects compliant with a file format standard for personal data interchange. In this embodiment, accordingly, the generator means of the administration device is adapted for generating a data object in accordance with said file format standard for personal data interchange.

For such an embodiment, the file format standard for personal data interchange is advantageously selected from the group consisting of vCard, vCalendar, hCard, iCalendar, and any standard compatible therewith. This embodiment of the invention therefore uses an existing file format standard for personal data interchange (PDI) for a novel access control purpose to provide temporary access for a wireless key device to a lock device and its protected environment by creating appropriate temporary access defining data in a data object compliant with the PDI file format standard and communicating the data object to the lock device via the wireless key device. Since the conveyed data object complies with an existing PDI file format standard, the only requirements put on the wireless key device are that it shall contain software (or other functionality) compatible with the PDI file format standard and be capable of receiving and forwarding a data object in this PDI file format standard by means of a short-range wireless data communication means. There is no need for the wireless key device to have customized access control software installed.

In another advantageous embodiment of the invention, the file format standard used for said data object by the data interchange means of the wireless key device and by the generator means of the administration device is a file format standard for media data interchange, preferably an image file interchange format standard such as JFIF (“JPEG File Interchange Format”, Exif (“Exchangeable image file format”) or TIFF (“Tagged Image File Format”), or any standard compatible therewith, or an audio or video file interchange format standard, or any other predefined and commercially spread file format standard for data objects.

Since numerous kinds of portable communication devices like mobile terminals are compliant with PDI file format standards like vCard (Versitcard), hCard, iCalendar or vCalendar, and/or file format standards for media data interchange as mentioned above, and furthermore have short-range wireless data communication means such as a Bluetooth® radio transceiver, the wireless key device is advantageously a mobile terminal, such as a mobile phone or a personal digital assistant (PDA), suitable for telecommunication with a mobile telecommunications network compliant with for instance GSM, UMTS, D-AMPS, CDMA2000, FOMA or TD-SCDMA.

In one or more embodiments, the transmitter means of the administration device comprises a network interface to a communications network, for instance in the form of or including a mobile telecommunications network. The transmitter means also has means for including the generated data object in a digital message, such as an SMS (“Short Message Service”, MMS (“Multimedia Messaging Service”) or email message, and for transmitting said digital message addressed to said wireless key device via said network interface over said communications network. Thus, the administration device may advantageously be a server computer or a mobile terminal.

Embedding the generated data object in a digital message represents a convenient transport channel for the generated data object from the administration device to the wireless key device. This is particularly convenient when a mobile terminal is used as the wireless key device, since mobile terminals are very often provided with standard utility software which includes a messaging application and a contacts application. Therefore, such standard utility software in the mobile terminal will conveniently implement the required data interchange means of the wireless key device, as referred to above, by allowing the mobile terminal user to receive the digital message from the administration device, temporarily save the embedded data object in the mobile terminal and then have it forwarded to the lock device by way of Bluetooth® communication.

A second aspect of the invention is an administration device for an access control system which further includes a wireless key device and a lock device of a type having a short-range wireless data communication means capable of short-range wireless data communication based on a communication identifier of said lock device. The administration device comprises:

generator means for generating a data object in accordance with a file format standard, a first property of said generated data object being assigned the communication identifier of said lock device, and at least a second property of said generated data object being assigned temporary access defining data for a wireless key device to an environment protected by said lock device, and

transmitter means for transmitting said generated data object to said key device.

The temporary access defining data, which is assigned by said generator means to said second property of said generated data object, may include temporal data which defines one or more time frames during which access is permitted for said key device to said protected environment. In one or more embodiments, such temporal data is specified in a calendar data format, for instance in the form of one of more dates and/or times which define start and end points for permitted temporary access.

The temporary access defining data may include usage limitation data which defines how many times said key device is permitted to access said protected environment.

The generator means may be adapted to encrypt at least one of said first and second properties of said data object using an encryption key which includes said communication identifier of said lock device. This encryption key may also include a unique serial number of said lock device. Thus, in one embodiment, enhanced security is obtained by configuring the administration device to encrypt the contents of the generated data object, using as encryption key the communication address (Bluetooth® address) of the lock device's radio transceiver as well as a serial No of the lock device, provided by its manufacturer and prestored in local memory of the lock device. This will eliminate any need for a separate communication of the decryption key from the administration device to the lock device.

It is to be noticed that the terms “first property” and “second property” as used above for the generated data object are to be interpreted openly without any specific limitations as regards the order of their actual appearance in the data structure of the generated data object. Thus, the “first property” can actually appear after the “second property” in the data structure, and the generated data object can have other properties as well, which may appear before, after or between the “first property” and “second property”. Moreover, the “first and second properties” need to be two properties only on a logical level; the data they are assigned may be physically stored in one common data field in the generated data object, or be distributed among a plurality of physical data fields.

It is also to be noticed that the “access control means [being] responsive to successful verification by said verification means”, as specified for the lock device, shall not be construed in any more limiting way than to mean that a match between the first property of the received data object and the communication identifier of the lock device is a requisite for the lock device to be able to grant temporary access. Whether or not such temporary access will be granted will in addition depend on the temporary access defining data for the key device, as conveyed by the second property of the received data object.

A third aspect of the present invention is a lock device for a protected environment in an access control system which further includes an administration device and a wireless key device, the lock device comprising:

short-range wireless data communication means capable of short-range wireless data communication with said key device based on a communication identifier of said lock device and capable of receiving from said key device a data object which originates from said administration device and complies with a file format standard;

processing means, associated with said short-range wireless data communication means, for processing the received data object to derive a first property and a second property of the data object;

verification means for verifying that said first property matches the communication identifier of the lock device; and

access control means, responsive to successful verification by said verification means, for providing temporary access for said key device in accordance with said second property.

The processing means, verification means and access control means may be implemented in various different ways. In one embodiment, they are all implemented by a processor which is programmed to provide the above-mentioned processing, verification and access control functionality. In other embodiments, these means may instead be implemented in hardware (e.g. as one or more application-specific integrated circuits (ASICs), or as one or more field programmable gate arrays (FPGA), or as basically any other available form of electronic logic circuitry configurable to perform the specified processing, verification and access control functionality.

In one or more embodiments, the processing means is configured to detect a communication identifier of the key device (such as its Bluetooth® address), wherein the access control means is configured to:

create a database record for the key device,

enter the detected communication identifier into the database record,

enter temporary access defining data, represented by the derived second property of the data object, for the key device into the database record, and

store the database record in a local access control database in the lock device.

Creating a database record for the key device in a local access control database in the lock device allows for multiple temporary accesses for the key device based on just one transmission of a single data object in e.g. a digital message from the administration device via the key device to the lock device. The first time the key device connects to the lock device, the data object will be transmitted to the lock device, and the database record will be created. Provided that the temporary access defining data so permits, the key device will then be granted temporary access a first time to the lock device. Then, when the key device seeks access a second time to the lock device, there is no need to transmit a data object at this time, since a database record already exists for the key device in the lock device's local access control database. Therefore, on condition that the temporary access defining data of this database record so permits, the key device may be granted a second temporary access to the lock device by simply detecting the communication identifier (e.g. Bluetooth® address) of the key device.

To this end, to facilitate multiple temporary accesses in this way, the temporary access defining data (represented by the second property of the data object) may include usage limitation data which defines how many times the key device is permitted to access the protected environment.

The temporary access defining data may also include temporal data which defines one or more time frames during which access is permitted for the key device to the protected environment.

The processing means may be configured to decrypt at least one of said first and second properties of said data object using a decryption key which includes said communication identifier of said lock device. The decryption key used by said processing means may also include a unique serial number of said lock device.

In one or more embodiments, the processing means is further adapted to derive a third property of the data object in the form of a unique data object identifier set by the administration device, wherein the verification means is further adapted to verify that said third property matches one of a number of allowed unique data object identifiers which have been prestored in local memory in the lock device.

In addition, the verification means may be further adapted to delete or mark as consumed a matching one of the prestored unique data object identifiers so as to prohibit future use by a key device of a data object having the same data object identifier as said matching one in an attempt to obtain temporary access through said lock device to said protected environment.

Using prestored unique data object identifiers in this way to allow one-time use only of a certain data object will increase the security and counteract malicious repeated use of the same data object. This may be an important advantage particularly in embodiments where the data object is conveyed in a digital message from administration device to key device (digital messages being easy to copy, relay or forward to other key devices than the receiver intended by the administration device).

Additional aspects of the invention relate to associated methods and computer program products.

The additional aspects of the invention may have the same or corresponding features as any of the embodiments referred to above for the first, second or third aspect of the invention. Likewise, the access control system according to the first aspect may include any of the features of the administration device according to the second aspect and/or the lock device according to the third aspect.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objectives, features and advantages of the present invention, will be better understood through the following illustrative and non-limiting detailed description of embodiments of the present invention, reference being made to the appended drawings in which:

FIG. 1 is a schematic illustration of an access control system, including an administration device, a wireless key device and a lock device,

FIG. 2 is a schematic front view illustrating a wireless key device according to one embodiment,

FIG. 3 is a schematic block diagram illustrating internal components and modules of a lock device according to one embodiment,

FIG. 4a illustrates a data structure for a data object which is compliant with a file format standard for personal data interchange and which may be used for providing temporary access for the key device to an environment protected by the lock device,

FIG. 4b gives an example of a data object generated in accordance with the data structure of FIG. 4a,

FIG. 5a is a flowchart diagram of a method performed by the administration device to assist in providing temporary access for the key device,

FIG. 5b is a flowchart diagram of a method performed by the key device to assist in providing temporary access for the same,

FIG. 5c is a flowchart diagram of a method performed by the lock device to assist in providing temporary access for the key device, and

FIG. 6 is a flowchart diagram which illustrates an access control method performed by the lock device according to one embodiment.

### DETAILED DESCRIPTION OF EMBODIMENTS

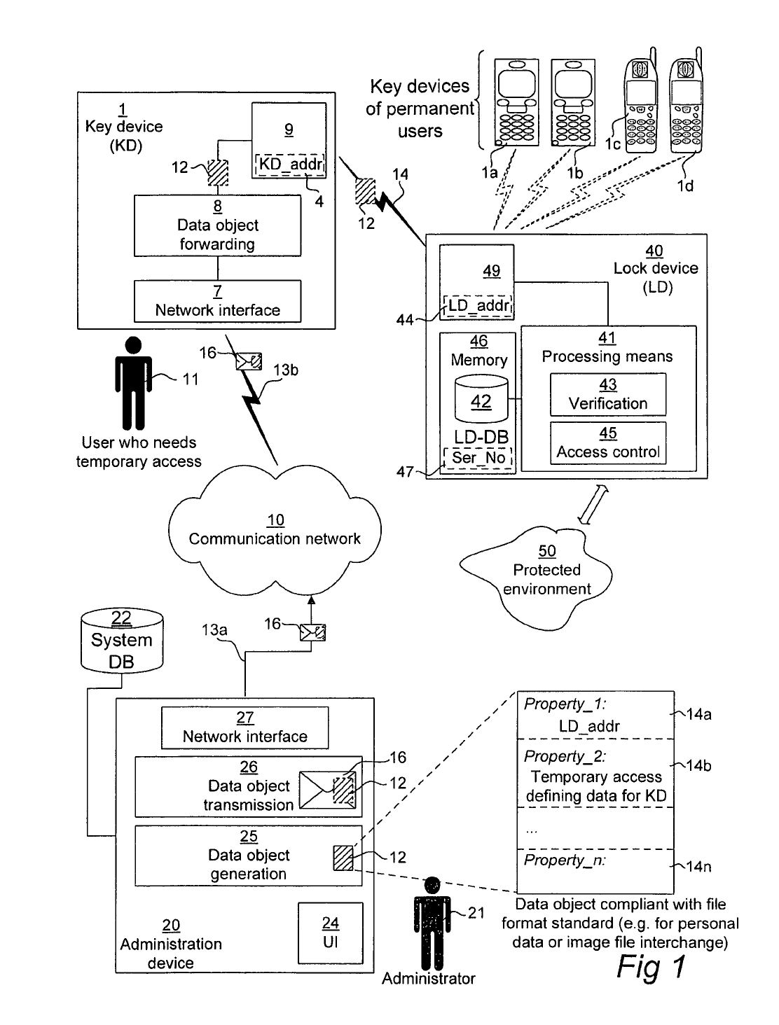

Generally, in the exemplifying access control system of FIG. 1, a user 11 needs temporary access to an environment 50 protected by a lock device 40. An administrator 21 can make this temporary access possible by creating, with the aid of an administration device 20, appropriate temporary access defining data for the user 11 and have it communicated to a wireless key device 1 which the user 11 is in possession of. The user 11 will then use his wireless key device 1 to forward the received temporary access defining data wirelessly to the lock device 40, which upon processing of the temporary access defining data may take the necessary actions to grant the intended temporary access for the user 11 to the protected environment 50.

The protected environment 50 may for instance be a room, apartment, commercial or public premises, garage, cabinet, locker, etc, with a controllable physical access interface in the form of a lockable door, garage port, hatch, etc. To this end, the lock device 40 will be integrated with or coupled to a lock mechanism in the lockable door or garage port and in particular have a controllable lock actuator configured to unlock the lock mechanism upon detection and successful authorization of the key device 1, based on the temporary access defining data, or another key device which already has been defined in the lock device 40 as authorized to access the protected environment 50 (see “key devices 1a-1d of permanent users” in FIG. 1). One possible lock actuator is shown in the afore-mentioned WO 2006/098690 and involves an electromechanical arrangement with an electric step motor, but various other arrangements are of course also possible within the context of the present invention.

The structure and functionality of the administration device 20, key device 1 and lock device 40 will now be described in more detail in the following.

In the disclosed embodiment, the administration device 20 is a computer, such as a personal computer, workstation or server computer, having a user interface 24 in the form of input devices such as keyboard and mouse, an output device such as a display (e.g. liquid crystal display monitor or cathode ray tube monitor), and an operating system with a graphical user interface (GUI). In other embodiments, the administration device 20 may for instance be a mobile terminal.

The administration device 20 has access control administration software by means of which the administrator 21 may control which users (or more specifically which key devices held by such users) that shall have access to the protected environment of the lock device 40, as well as of other lock devices if included in the access control system. Thus, the access control administration software may contain various functionality for controlling the access control rules for permanent users 1a-1d by communicating database upgrading data to the lock device 40 for storage in a local access control database 42 of the lock device 40. The afore-mentioned WO 2006/-098690 discloses particulars of such database upgrading.

In addition, in line with the objectives of the present invention, the access control administration software in the administration device 20 includes a system database 22 as well as functionality for creating, packaging and transmitting the temporary access defining data for the key device 1 and its user 11 who is to get temporary access to the lock device 40. In the disclosed embodiment, this functionality includes a data object generation module 25 which is configured to invite the administrator 21 to specify the temporary access defining data through interaction with the user interface 24.

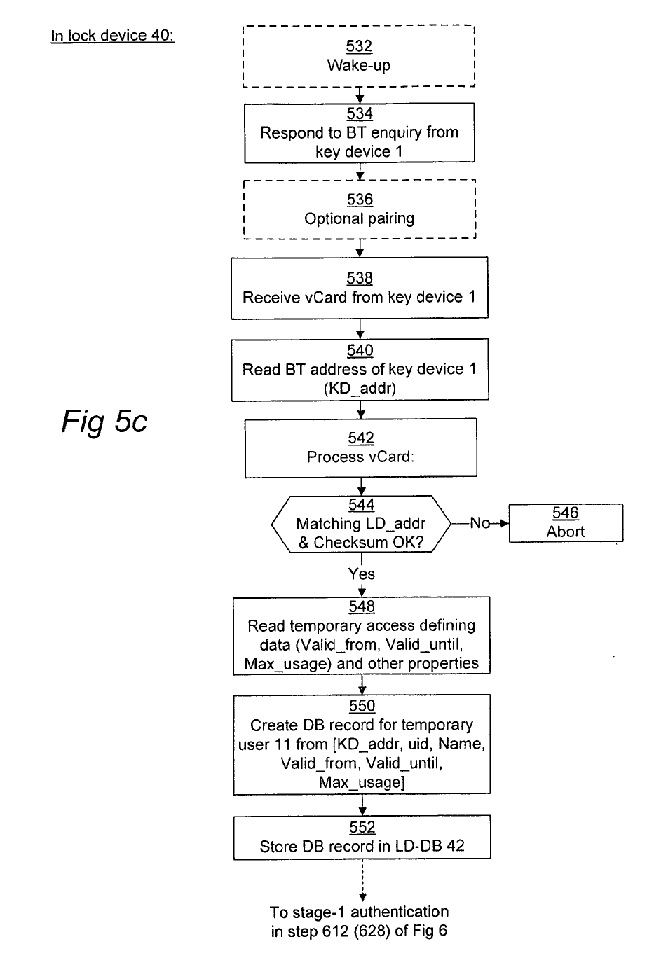

The data object generation module 25 is configured to create a data object 12 which complies with an existing file format standard for communication of data objects. The disclosed embodiment uses the personal data interchange (PDI) standard vCard. Also see step 502 of FIG. 5a. For more information on vCard, or on alternative PDI standards such as vCalendar, hCard and iCalendar, reference is made to the Internet Mail Consortium (http://www.imc.org/pdi/). A later section of this specification will refer to an alternative embodiment which instead uses a file format standard for image file interchange.

The created data object 12 is then assigned the data which is necessary for the lock device 40 to be able to grant temporary access for the key device 1. Also see step 504 of FIG. 5a. This necessary data includes a communication identifier (“LD_addr” in FIG. 1) of the lock device 40, and the temporary access defining data as specified by the administrator 21 for the key device 1. The communication identifier (“LD_addr”), too, is conveniently specified or otherwise selected through interaction with the user interface 24. In the disclosed embodiment, the lock device 40 has short-range wireless data communication means 49 in the form of a Bluetooth® transceiver, and therefore the communication identifier specified in the created data object 12 in the administration device 20 is conveniently the Bluetooth® address 44 of the lock device's 40 Bluetooth® transceiver 49.

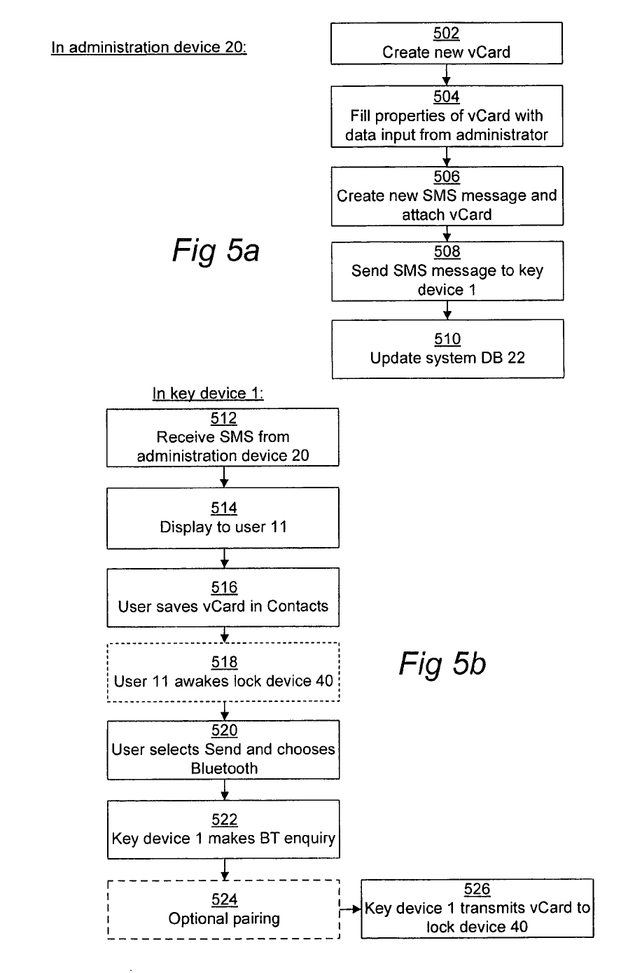

In the disclosed embodiment, this necessary data is included in the generated vCard 12 by assigning a first property 14a the communication identifier “LD_addr”, and assigning a second property 14b the specified temporary access defining data. As seen more clearly in FIGS. 4a and 4b, the generated vCard 12 may contain additional properties, such as a Formatted Name 14c, a Unique Identifier 14d of the generated vCard, a Name 14e of the user 11, and a Checksum 14f of the data contained in the other properties.

In some embodiments, the data of some or all of the vCard properties 14a-14f may be encrypted by the data object generation module 25, preferably using as encryption key the communication identifier (Bluetooth® address) of the lock device's radio transceiver 49 and, optionally, also a serial No 47 of the lock device 40, the latter having been prestored in local memory 46 of the lock device by for instance the manufacturer.

In the disclosed embodiment of FIGS. 4a and 4b, the temporary access defining data assigned to the second vCard property 14b includes temporal data which defines one or more time frames during which access is permitted for the key device 1 to the protected environment 50. Such temporal data may be specified in a calendar data format, for instance in the form of one of more dates and/or times which define start point (“Valid_from”) and end point (“Valid_to”) for the temporary access permitted.

Additionally, in the disclosed embodiment, the temporary access defining data includes usage limitation data which defines how many times the key device 1 is permitted to access the protected environment 50. Such usage limitation data may for instance be in the form of a maximum counter value (“Max_usage”). When such a maximum counter value is used and is greater than 1, the lock device 40 will keep a counter value associated with the stored temporary access defining data for the key device 1 in the local access control database 42. Each time the key device 1 seeks access through the lock device 40, the lock device will check that the current counter value permits temporary access in view of the maximum counter value, and increment the counter value each time temporary access is granted for the key device 1.

The administration device 20 also has a data object transmission module 26, associated with a network interface 27. The data object transmission module includes the generated data object 12 in a digital entity suitable for communication to the key device 1 over a communication network 10. Also see steps 506 and 508 of FIG. 5a. In the disclosed embodiment, the data object transmission module 26 creates a digital message 16, such as an SMS, attaches the data object 12 (vCard) to this digital message and addresses it to the key device 1. The network interface 27 transmits the digital message 16 onto the communication network 10, as seen at 13a in FIG. 1 and step 508 in FIG. 5a. The system database 22 is updated accordingly in step 510 of FIG. 5a.

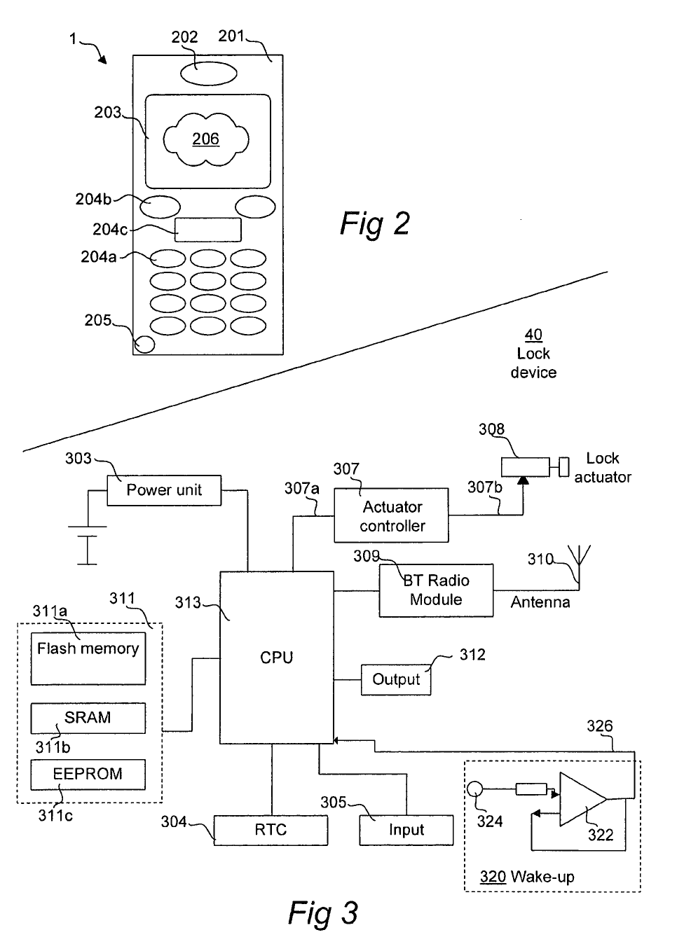

In the disclosed embodiment, the key device 1 is a mobile terminal (FIG. 2), and at least part of the communication network 10 is a mobile telecommunications network compliant with for instance GSM, UMTS, D-AMPS, CDMA2000, FOMA or TD-SCDMA. The communication network 10 may in addition comprise a wide-area data communication network, for instance being a part of the Internet. Appropriate interface equipment is provided in the communication network 10 to allow forwarding of the digital message 16, as received from the network interface 27 of the administration device 20, to the key device 1, as seen at 13b in FIG. 1.

As seen in FIG. 2, in a familiar manner, the mobile terminal comprises an apparatus housing 201, a loudspeaker 202, a display 203, an input device 204a-c, and a microphone 205. In the disclosed embodiment, the input device 204a-c includes a set of keys 204a arranged in a keypad of common ITU-T type (alpha-numerical keypad), a pair of soft keys or function keys 204b, and a biometrical data reader 204c in the form of a fingerprint sensor. Hence, a graphical user interface 206 is provided, which may be used by a user of the mobile terminal to control the terminal's functionality and get access to any of the telecommunications services referred to above, or to any other software application executing in the mobile terminal.

Being a mobile terminal in the disclosed embodiment, the key device 1 also has a network interface 7 (FIG. 1) in the form of cellular radio circuitry compliant with the mobile telecommunications network of the communication network 10. The key device also has data object forwarding functionality 8 capable of receiving the digital message 16 and forwarding the attached vCard data object 12 through short-range wireless data communication means 9 to the lock device 40, as seen at 14 in FIG. 1 and in FIG. 5b. In the disclosed embodiment, the short-range wireless data communication means 9 is a Bluetooth® transceiver 9 having a Bluetooth® address 4 (“KD_addr”).

Thus, the interface 7 and functionality 8 together constitute data interchange means capable of receiving the data object 12 with its included temporary access defining data from the administration device 20 and forwarding the data object to the lock device 40 with the aid of the short-range wireless data communication means 9. In the disclosed mobile terminal embodiment of the key device 1, the mobile terminal comprises standard messaging and contacts handling software, in the form of a messaging application and a contacts application (or in the form of a combined application for messaging and contacts). Thus, the steps to be performed in the key device 1 when receiving the digital message 16 are as shown in FIG. 5b:

In step 512, the messaging application receives the SMS 16 from the administration device and detects the attached vCard 12. A new message alert is shown in step 514 to the user 11 on the display 203, advantageously showing the contents of the Formatted Name property 14c (which may contain an explanatory text for the user 11 as seen in FIG. 4b) and inviting the user 11 to save the attached vCard as a record in the Contacts application (step 516).

When the appropriate time comes to enter the protected environment 50, the user 11 will bring his wireless key device 1 to the correct lock device 40 and retrieve the previously stored record in the Contacts application. By selecting an option like “Send by Bluetooth®”, in step 520, the user 11 will cause the key device 1 to attempt to establish short-range data communication 14 with the lock device 40 in step 522 by making a Bluetooth® enquiry. First, however, there may be an optional wake-up stage 518, for the purposes which are described below.

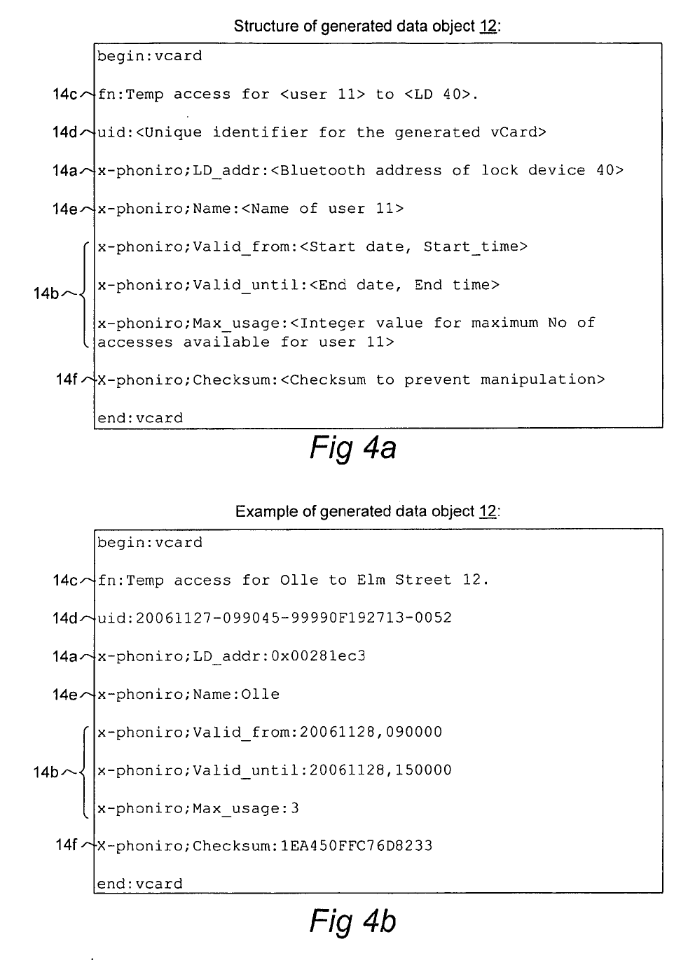

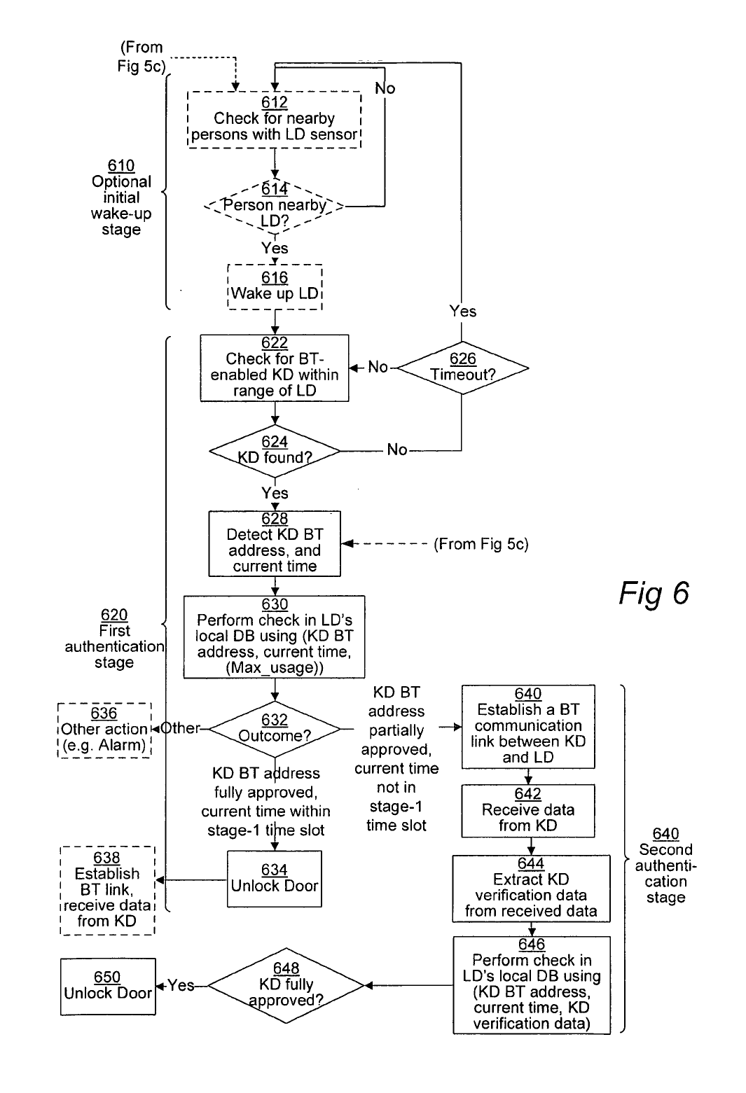

In the disclosed embodiment, the lock device 40 is operable in a sleep mode and an operational mode. The purpose of the sleep mode is to keep as much as possible of the electronics in the lock device in a shut-off or disabled condition so as to minimize the power consumption during periods of inactivity. Therefore, as is also seen at 610 in FIG. 6 as well as in FIG. 3, the lock device of the disclosed embodiment has a wake-up arrangement 320 capable of performing an initial wake-up step 532 in FIG. 5c (see also steps 612-616 in FIG. 6). During this wake-up step 532, the lock device 40 may be awaken and brought from its sleep mode into operational mode. The wake-up arrangement has a proximity sensor 324 positioned and configured to detect the presence of a user or key device near the lock device.

Whereas various different proximity sensors 324 are possible (including IR sensors, optical sensors, RF sensors, pressure sensors, and electrical switches), the disclosed embodiment of the lock device 40 uses an acoustic or vibration sensor 324 which is adapted to detect door knocks on a door to which the lock device 40 is mounted. Such a sensor may be provided in the form of a microphone which is attached via a spacer to the door leaf. The spacer will transfer vibrations caused by door knocks to the microphone. The wake-up arrangement 320 has circuitry 322 which is programmed or designed to apply predetermined wake-up criteria when deciding whether or not to generate a wake-up control signal 326 which will trigger the transition from sleep mode to operational mode. Such wake-up criteria may for instance be the detection of more than one door knock within a certain time frame. This may prevent an accidental wake-up because of a spurious detection of a non-related sound from the environment. Even more advanced wake-up criteria may be used, such as a given sequence of short and long door knocks, much like a code of Morse signals.

To this end, the disclosed embodiment of the lock device 40 is configured to react on a special door-knocking sequence which is to be used when a user like user 11 seeks temporary access by means of a key device, like key device 1, which is not known on beforehand to the lock device 40. This special door-knocking sequence is thus different from a normal door-knocking sequence which is to be used by permanent users of key devices 1a-1d.

Referring back to step 518 of FIG. 5b, the user 11 is assumed to generate this special door-knocking sequence on the door of the lock device 40 sufficiently early, so that the lock device 40 will have time to wake up in step 532 of FIG. 5c and enter its operational mode. Then, in step 534, the lock device responds to the Bluetooth® enquiry from the key device 1.

If more than one lock device respond to the Bluetooth® enquiry, the user 11 will be prompted to select the desired one in step 522.

Optionally, a pairing procedure may be performed between the key device 1 (step 524) and lock device 40 (step 536). Such a pairing procedure may increase the security and may therefore require the user 11 to enter a PIN or other verification on the key device 1. The lock device will verify in the optional step 536 that the PIN is correct before it allows any further communication with the key device 1. Such a PIN may have been communicated in advance from the administrator 21 to the user 11 over a separate channel, for instance during a voice call.

When a Bluetooth® link 14 has been duly established between the key device 1 and lock device 40, the data object (vCard) 12 will be transmitted by the key device 1 in step 526 and be received by the lock device 40 in step 538.

In a step 540, the lock device 40 detects the communication identifier (Bluetooth® address, “KD_addr”) 4 of the key device 1.

The lock device 40 has processing means 41 for processing the received data object 12 in steps 542-552 of FIG. 5c to derive its first property 14a and second property 14b, plus additional properties 14c-14f if applicable. If the data object was encrypted at the administration device 20, the processing means 41 performs decryption as has already been described above.

Verification means 43 are provided for verifying that the first property 14a of the received data object 12 matches the communication identifier (Bluetooth® address, “LD_addr”) 44 of the lock device in a step 544. If a Checksum property is used, the verification also includes verifying that the Checksum as derived from the property 14f of the received data object 12 corresponds to a checksum calculated for the other properties in the received data object 12.

In case of verification failure, the execution ends in step 546, and otherwise it continues to step 548 where access control means 45 acts to provide the desired temporary access for the key device 1 by reading the temporary access defining data represented by the second property 14b of the received data object 12. Then, in a step 550, a database record is created for the key device 1 in the lock device's local access control database 42. Data fields of this database record are filled with the key device's Bluetooth® address (“KD_addr”) as detected in step 540, with the temporary access defining data, and with other appropriate data from the received data object 12, such as the Name and Unique Identifier properties 14d and 14e. The database record is stored in step 552.

Now, in the disclosed embodiment, to actually let the user 11 into the protected environment 50, the execution proceeds by entering the normal access control authorization routine, which is normally used for permanent users, at step 612 in FIG. 6 (if no wake-up stage is used, the entry point may instead be at step 628, as indicated in FIGS. 5c and 6).

The access control authorization routine of FIG. 6 will soon be described in detail. First, however, components of the lock device 40 according to the disclosed embodiment will be briefly described with reference to FIG. 3.

The lock device 40 has a lock actuator 308 in the form of for instance an electric motor or a relay. The lock actuator 308 is coupled to a lock mechanism in a lockable door, garage port, etc, which forms a controllable entry to the protected environment 50. An actuator controller 307 is coupled to the lock actuator 308 and is adapted to provide a control signal 307b for engaging or disengaging the lock actuator 308 to cause unlocking when appropriate.

In turn, the actuator controller 307 is controlled by a control signal 307a from a CPU 313 in the lock device 40.

The CPU 313 is programmed to read and execute program instructions stored in a memory 311 so as to perform a method for wireless automatic unlocking in response to the appearance and proper authentication of a key device. The CPU may be identical to the aforementioned processing means 41, and the memory 311 may be identical to the aforementioned local memory 46.

The lock device 40 of this embodiment is a stand-alone, autonomously operating device which requires no wire-based installations, neither for communication nor for power supply. Instead, the lock device 40 is powered solely by a local battery power unit 303 and interacts with the key device, as already mentioned, by Bluetooth®-based activities. To this end, the lock device 40 has a Bluetooth® radio module 309 with an antenna 310. The Bluetooth® radio module 309 may be identical to the aforementioned communication means 49.

The lock device 40 of the disclosed embodiment further includes a real-time clock 304 capable of providing the CPU 313 with an accurate value of the current time.

The lock device 40 may have a simple user interface involving input device(s) 305 and output device(s) 312. In some embodiments, an authorized administrator may configure the lock device 40 manually through this user interface.

Since the lock device 40 is a stand-alone, battery-powered installation which is intended to be operative for long time periods without maintenance, it is desired to keep power consumption at a minimum. Therefore, the disclosed embodiment is provided with the wake-up arrangement 320 which has already been referred to above.

Reference is now again made to the access control authorization routine of FIG. 6. On a general level, the method consists of two main authentication stages 620 and 640, and, in the present embodiment but optionally, the initial wake-up stage 610. The first authentication stage 620 is designed to be fast and therefore does not involve any establishment of a two-way Bluetooth® communication link between lock device and key device.

In the first authentication stage, authorization is based solely on the key device's Bluetooth® address and the current time, both of which are detected automatically by the lock device 40 and require no interaction from the user (other than bringing the key device near the lock device 40). Certain users are entrusted to enter the protected environment simply through this first authentication stage 620, whereas other users must be authorized during the following, second and more extensive authentication stage 640 which requires establishment of a two-way Bluetooth® communication link and involves additional verification data from the key device 100—for instance in the form of a PIN code or biometric data. Temporary users, such as user 11 of the key device 1, will also get access through the first authentication stage 620.

The lock device 40 bases its operation upon the authentication data (access control data) stored in LD-DB 42. In the present embodiment, the record structure of the LD-DB 42 includes the following data fields for authentication data:

| | | Contents |
|---|---|---|
| Field | Contents example #1 | example #2 |
| LD ID | 121 | 121 |
| User name | Lars | Jonas |
| Key device BT ID | 0x00223af3 | 0x002e5af4 |
| Stage-1 time slot (1) | 2005-03-24: 19-22 | |
| Stage-1 time slot (2) | Mon-Fri: 07-15 | |
| . . . | | |
| Stage-1 time slot (n) | | |
| Stage-2 time slot - single | | |
| Stage-2 time slot - scheduled | 00-24 | Sat-Sun: 10-18 |
| PIN code | **** | **** |
| Administrator | No | No |

In the example given above, it is thus configured that permanent user Lars is authorized for access through the lock device 40 having ID 121, by using his key device having Bluetooth® ID 0x00223af3 by fast stage-1 authentication during working days between 07:00 and 15:00. He was also granted a single stage-1 authority on 24 Mar. 2005 between 19:00 and 22:00. If he arrives at the door outside of these stage-1 time slots, he may still access the door at any time (00-24), but in such a case he must go through a more complex stage-2 authentication which involves additional authorization, namely by providing a PIN code from the key device and having it communicated to the lock device 40 over a two-way Bluetooth® communication link. Thus, stage-2 authentication requires a special software in the key device, since data exchange is involved. Therefore, if mobile terminals are used as key devices for permanent users, they are preferably of an advanced model provided with a suitable operating system, such as Symbian, at least for users that require stage-2 authentication.

As regards the PIN code, it may either be prestored in memory in the key device and fetched by the software therein upon communication to the lock device, or the software may invite the user to enter his PIN code manually on e.g. the keypad 204a upon establishment of the two-way Bluetooth® communication link. In other embodiments, if biometric data instead of PIN code is used as verification data, they are treated in the corresponding way, i.e. either prestored in memory or read by e.g. the fingerprint sensor 204c. It is to be observed that all communication between key device and lock device may be encrypted in accordance with an encryption algorithm, such as Blowfish. Therefore, data integrity is ascertained.

As for permanent user Jonas, only stage 2-authentication is available to him, and only on weekends between 10:00 and 18:00.

In addition to the exemplifying database records above and continuing with the use case example described above with reference to the preceding figures, the LD-DB 42 will also of course contain the database record created for temporary user Olle (see FIG. 4b). This database record will, as previously explained, contain the temporary access defining data in the form of the time frame(s) for the permitted temporary access, as well as the maximum usage counter value if applicable.

With reference to FIG. 6, assuming that the lock device 40 is in sleep mode, the initial wake-up stage 610 is performed in steps 612, 614 and 616 by using the proximity sensor 324 to detect the presence of the user of key device 1 near the lock device 40 and in response generate the wake-up control signal 326 to the CPU 313.

This causes the CPU 313 to enter the first authentication stage 620. A step 622 searches for Bluetooth®-enabled devices by paging, i.e. sending inquiry requests at regular intervals. Each Bluetooth®-enabled device within operating range (i.e. within a radius of some meters from the lock device 40, depending on e.g. the output power of the Bluetooth® radio module 309 and the performance of the Bluetooth® transceivers in the devices paged for) will transmit an inquiry response to the lock device. It is checked in step 624 whether at least one inquiry response is received within a time limit; if not a time out 626 occurs and the lock device 40 returns to sleep mode.

If an inquiry response was received, step 628 proceeds to determine the Bluetooth® address from the inquiry response. Moreover, a current time is determined by reading a value from the real-time clock 304.

Then, the CPU 313 proceeds in step 630 to check whether the determined Bluetooth® address of the responding device matches one of afore-described authentication data records in the LD-DB 42. In case of a match, it is also checked whether the current time falls within any stage-1 time slot defined for that Bluetooth® address. If the outcome of these checks is fully positive, as checked in step 632, the CPU 313 proceeds to step 634 and generates the control signal 307a to the actuator controller 307. As described above, this will cause unlocking of the lock, etc, and allow opening of the door, etc, to the protected environment.

If the check in step 632 reveals that the determined Bluetooth® address is not present in the LD-DB 42, or that the Bluetooth® address is present but the current time matches neither a stage-1 time slot nor a stage-2 time slot for that address, then no unlocking will take place, and the execution will return to step 622. In some embodiments it is possible to list certain undesired Bluetooth® addresses as explicitly forbidden in LD-DB 42. If the determined Bluetooth® address matches such a forbidden Bluetooth® address, appropriate action may be taken in a step 636, such as generating an alarm signal or registering the access attempt in memory 311 for later reporting.

If the check in step 632 reveals that the determined Bluetooth® address is present in the LD-DB 42, but that the current time does not fall within any stage-1 time slot defined for that Bluetooth® address but only within a stage-2 time slot, the execution proceeds to step 640.

In step 640, the CPU controls the Bluetooth® radio module 309 to establish a two-way Bluetooth® communication link with the key device detected in step 628. In step 642, data transmitted by the software in the key device is received in the lock device 40. Step 644 extracts verification data, such as a PIN code for key device, which as previously explained is included in the received data. Then, in step 646 it is checked whether the extracted verification data matches the corresponding authentication data stored for the key device's Bluetooth® address in LD-DB 42. In case of a match, step 648, the CPU 313 proceeds to step 650 and generates the control signal 307a to the actuator controller 307. Again, this will cause unlocking and allow the door, etc, to be opened.

Instead of a personal data interchange (PDI) standard like vCard, an alternative embodiment of the invention is based on a file format standard for image file interchange. In this embodiment, the data object generation module 25 of the administration device 20 is thus configured to create a data object 12 which complies with an existing image file interchange format standard such as JFIF (“JPEG File Interchange Format”), Exif (“Exchangeable image file format”) or TIFF (“Tagged Image File Format”). Metadata tags available in accordance with the chosen image file interchange format standard may conveniently be used to implement the first property 14a of the image file object (for storing the communication identifier of the lock device 40), and the second property 14b (for storing the specified temporary access defining data). As non-limiting examples, the MakerNote tag may be used if the data object 12 is an Exif object, whereas the thumbnail data field may be used if the data object 12 is a JFIF object, etc. As an alternative, new metadata tags may be defined and used, provided that the chosen image file interchange format standard so permits.

Alternatively, the contents of some or all of the generated data object's 12 properties 14a-14n may be stored with the payload data of the data object (for instance embedded in the JPEG image data, when the data object 12 is a JFIF image object). This may be useful if the chosen file format standard does not support metadata tags. It may also be used as a measure to improve security—if the data object's 12 properties 14a-14n are hidden as distributed data among JPEG image data representing a dummy image, it will be difficult for a third party to localize the positions in the image data where the properties 14a-14n are stored and, thus, make manipulation attempts harder.

An advantage of using a file format standard for image file interchange instead of personal data interchange is that less manual steps may be required by the user 11 in order to receive and forward the data object 12 in the message 16. In some mobile terminals, a received image can be forwarded directly from the inbox of the messaging application, without having to store it temporarily in for instance a Contacts application.

In one alternative embodiment, the access control system uses one-time tickets to enhance the security when it comes to providing temporary access. To this end, each lock device 40 is initially provided with a prestored set of one-time tickets, for instance 100 tickets. The system database 22 of the administration device 20 will keep track of the one-time tickets as they have been used for each lock device 40. When a data object 12 is to be generated (step 504 of FIG. 5a), the data object generation module 25 will determine the next available one-time ticket to use for the lock device 40 in question, and also include this particular one-time ticket in any of the properties 14a-14n of the data object 12. The one-time ticket may be represented as a sequence of hexadecimal data (for instance the unique data object identifier 14d as described above for FIGS. 4a and 4b), or it may be generated in a more sophisticated way as a function of one or more unique parameters of the lock device 40 in question, such as its communication identifier (e.g. Bluetooth® address 44) and the temporal data included in the temporary access defining data. Upon receipt of the data object 12, the lock device will derive the one-time ticket included therein and verify that it matches a valid (not already used) ticket in the prestored set of one-time tickets (steps 542-544 of FIG. 5c). The lock device 40 will then scrap (e.g. delete or marked as used) the particular one-time ticket from the prestored set, so that it cannot be used again for a future temporary access to this particular lock device 40. Security may be enhanced further by requiring that the one-time tickets be used in sequential order (i.e., only one ticket (the one “first in line” among the non-used ones) will be valid at a time).

The invention has mainly been described above with reference to a few embodiments. However, as is readily appreciated by a person skilled in the art, other embodiments than the ones disclosed above are equally possible within the scope of the invention, as defined by the appended patent claims. Further, even if the disclosed embodiments use Bluetooth® for the short-range wireless data communication, another communication standard is also feasible, including but not limited to IrDA or a wireless local area network (WLAN) standard such as IEEE 802.11, IEEE 802.11a, IEEE 802.11b, IEEE 802.11g, HiperLAN2, WiMAX (IEEE 802.16), or HomeRF.

1. An access control system including:
a lock device (40) for a protected environment (50), said lock device comprising short-range wireless data communication means (49) capable of short-range wireless data communication based on a communication identifier (44) of said lock device;
a wireless key device (1) having short-range wireless data communication means (9) and data interchange means (7, 8) for communication of data objects compliant with a file format standard; and
an administration device (20) comprising:
generator means (25) for generating a data object (12) in accordance with said file format standard, a first property (14a) of said generated data object being assigned the communication identifier (44) of said lock device (40), and at least a second property (14b) of said generated data object being assigned temporary access defining data for said key device (1) to said environment (50) protected by said lock device, and
transmitter means for transmitting said generated data object to said key device;
wherein said lock device (40) further comprises:
processing means (41), associated with said short-range wireless data communication means (49), for processing said data object (12) as received and forwarded by said key device (1),
verification means (43) for verifying that said first property (14a) of the received data object (12) matches the communication identifier (44) of the lock device, and
access control means (45), responsive to successful verification by said verification means, for providing temporary access for said key device (1) in accordance with said second property (14b) of the received data object (12).

2. An access control system as defined in claim 1, wherein the short-range wireless data communication means (49) of said lock device (40) comprises a radio transceiver and wherein the communication identifier (44) of said lock device is a unique communication address assigned to said radio transceiver.

3. An access control system as defined in claim 1 or 2, wherein said file format standard is a standard for personal data interchange selected from the group consisting of vCard, vCalendar, hCard, iCalendar, and any standard compatible therewith.

4. An access control system as defined in claim 1 or 2, wherein said file format standard is an image file interchange format standard selected from the group consisting of JFIF, Exif, TIFF, and any standard compatible therewith.

5. An access control system as defined in any preceding claim, wherein the transmitter means of said administration device (20) comprises
a network interface (27) to a communications network (10), and
means (26) for including said generated data object (12) in a digital message and for transmitting said digital message addressed to said wireless key device (1) via said network interface over said communications network.

6. An administration device (20) for an access control system which further includes a wireless key device and a lock device of a type having a short-range wireless data communication means (49) capable of short-range wireless data communication based on a communication identifier (44) of said lock device, the administration device comprising:
generator means (25) for generating a data object (12) in accordance with a file format standard, a first property (14a) of said generated data object being assigned the communication identifier (44) of said lock device (40), and at least a second property (14b) of said generated data object being assigned temporary access defining data for a wireless key device (1) to an environment (50) protected by said lock device, and
transmitter means for transmitting said generated data object to said key device.

7. An administration device as defined in claim 6, wherein said file format standard is a standard for personal data interchange selected from the group consisting of vCard, vCalendar, hCard, iCalendar, and any standard compatible therewith.

8. An administration device as defined in claim 6, wherein said file format standard is an image file interchange format standard selected from the group consisting of JFIF, Exif, TIFF, and any standard compatible therewith.

9. An administration device as defined in any of claims 6-8, the transmitter means comprising
a network interface (27) to a communications network (10), and
means (26) for including said generated data object (12) in a digital message and for transmitting said digital message addressed to said wireless key device (1) via said network interface over said communications network.

10. An administration device as defined in any of claims 6-9, wherein the temporary access defining data, which is assigned by said generator means (25) to said second property (14b) of said generated data object (12), includes temporal data which defines one or more time frames during which access is permitted for said key device (1) to said protected environment (50).

11. An administration device as defined in any of claims 6-10, wherein the temporary access defining data, which is assigned by said generator means (25) to said second property (14b) of said generated data object (12), includes usage limitation data which defines how many times said key device (1) is permitted to access said protected environment (50).

12. An administration device as defined in any of claims 6-11, wherein said generator means (25) is adapted to encrypt at least one of said first and second properties of said data object (12) using an encryption key which includes said communication identifier (44) of said lock device (40).

13. An administration device as defined in claim 12, wherein the encryption key used by said generator means (25) also includes a unique serial number of said lock device (40).

14. A lock device (40) for a protected environment (50) in an access control system which further includes an administration device (20) and a wireless key device (1), the lock device comprising:
short-range wireless data communication means (49) capable of short-range wireless data communication with said key device based on a communication identifier (44) of said lock device and capable of receiving from said key device a data object (12) which originates from said administration device (20) and complies with a file format standard;
processing means (41), associated with said short-range wireless data communication means (49), for processing the received data object (12) to derive a first property (14a) and a second property (14b) of the data object (12);
verification means (43) for verifying that said first property (14a) matches the communication identifier (44) of the lock device; and
access control means (45), responsive to successful verification by said verification means, for providing temporary access for said key device (1) in accordance with said second property (14b).

15. A lock device as defined in claim 14,
wherein the processing means (41) is configured to detect a communication identifier of the key device (1), and
wherein the access control means (45) is configured to
create a database record for the key device (1),
enter the detected communication identifier into the database record,
enter temporary access defining data, represented by the derived second property (14b) of the data object (12), for the key device (1) into the database record, and
store the database record in a local access control database (42) in the lock device (40).

16. A lock device as defined in claim 14 or 15, wherein the derived second property (14b) of the data object (12) represents temporary access defining data for the key device (1) to the lock device, said temporary access defining data including usage limitation data which defines how many times said key device (1) is permitted to access said protected environment (50).

17. A lock device as defined in any of claims 14-16, wherein the derived second property (14b) of the data object (12) represents temporary access defining data for the key device (1) to the lock device, said temporary access defining data including temporal data which defines one or more time frames during which access is permitted for said key device (1) to said protected environment (50).

18. A lock device as defined in any of claims 14-17, wherein said processing means (41) is configured to decrypt at least one of said first and second properties of said data object (12) using a decryption key which includes said communication identifier (44) of said lock device (40).

19. A lock device as defined in claim 18, wherein the decryption key used by said processing means (41) also includes a unique serial number of said lock device (40).

20. A lock device as defined in any of claims 14-19,
wherein the processing means (41) is further adapted to derive a third property (14d) of the data object (12) in the form of a unique data object identifier set by the administration device (20), and
wherein the verification means (43) is further adapted to verify that said third property (14d) matches one of a number of allowed unique data object identifiers which have been prestored in local memory in the lock device.

21. A lock device as defined in claim 20,
wherein the verification means (43) is further adapted to delete or mark as consumed a matching one of the prestored unique data object identifiers so as to prohibit future use by a key device of a data object having the same data object identifier as said matching one in an attempt to obtain temporary access through said lock device to said protected environment.

22. A method of providing temporary access for a wireless key device (1) to an environment (50) protected by a lock device (40), the method involving:
generating, in an administration device (20), a data object (12) in accordance with a file format standard;
assigning a communication identifier (44) of said lock device (40) to a first property (14a) of said generated data object;
assigning temporary access defining data for said key device (1) to at least a second property (14b) of said generated data object;
transmitting said generated data object from said administration device (20) to said key device;
receiving said data object (12) in said key device (1);
transmitting said data object (12) from said key device (1) to said lock device (40);
receiving said data object (12) in said lock device (40);
verifying that the first property (14a) of the received data object (12) matches the communication identifier (44) of the lock device; and
in response to successful verification by said verification means, providing temporary access for said key device (1) in accordance with the second property (14b) of the received data object (12).

23. A method in an administration device (20) for providing temporary access for a wireless key device (1) to an environment (50) protected by a lock device (40), the method comprising:
generating a data object (12) in accordance with a file format standard;
assigning a communication identifier (44) of said lock device (40) to a first property (14a) of said generated data object;
assigning temporary access defining data for said key device (1) to at least a second property (14b) of said generated data object; and
transmitting said generated data object to said key device.

24. A computer program product comprising program code which is loadable into a processor and executable to perform the method according to claim 23.

25. A method in a lock device for providing temporary access for a wireless key device (1) to an environment (50) protected by the lock device (40), the method comprising:
receiving from said key device a data object (12) which originates from an administration device (20) and complies with a file format standard;
processing the received data object (12) to derive a first property (14a) and a second property (14b) thereof;
verifying that said first property (14a) matches a communication identifier (44) of the lock device; and
in response to successful verification, providing temporary access for said key device (1) in accordance with said second property (14b).

26. A computer program product comprising program code which is loadable into a processor and executable to perform the method according to claim 25.
